(19) United States
(12) Patent Application Publication
(10) Pub. No.: US 2023/0047823 A1
(43) Pub. Date: Feb. 16, 2023

(54) MACHINE TOOL

(71) Applicant: FANUC CORPORATION, Yamanashi (JP)

(72) Inventors: Yuuya KAWASE, Yamanashi-ken (JP); Yuuta ISHII, Yamanashi-ken (JP); Takeshi OOKI, Yamanashi-ken (JP)

(21) Appl. No.: 17/792,165

(22) PCT Filed: Jan. 12, 2021
(86) PCT No.: PCT/JP2021/000669

§ 371 Date: Jul. 12, 2022

(30) Foreign Application Priority Data
Jan. 15, 2020 (JP) 2020-004049

(51) Int. Cl. B23Q 11/12

(52) U.S. Cl. CPC B23Q 11/12

(57) ABSTRACT

Provided is a machine tool capable of reducing the influence of vibration from the side of a base of a vibration removal device. A machine tool is provided with: a vibration removal device that is provided on a base and that blocks the vibration transmitted from the base; a frame which is disposed on the vibration removal device and on which the machine tool body is placed; a container that is disposed on the base, that is for storing a liquid, and that is connected to a hose for discharging the stored liquid; and a flow path that is provided to the frame and that is for passing the liquid flowing from the machine tool body to the end of the frame and pouring the liquid into the container.

### TECHNICAL FIELD

The present invention relates to a machine tool for machining a workpiece using a tool.

### BACKGROUND ART

JP 2003-285241 A discloses a machine tool that protects a linear motion slider from chips and oil mist by covering the linear motion slider mounted on a vibration isolation device (vibration isolation table) with a slide cover. In this machine tool, a pipe is connected to an oil reservoir of a rail of the linear motion slider, and the dust collector suctions oil stored in the oil reservoir, via the pipe.

### SUMMARY OF THE INVENTION

However, in the machine tool disclosed in JP 2003-285241 A, vibration from the base of the vibration isolation device may be transmitted to the rail of the linear motion slider via the pipe. In this case, there is a concern that the machining accuracy of the machine tool main body including the linear motion slider mounted on the vibration isolation device may be deteriorated.

An object of the present invention is to provide a machine tool which is capable of reducing the influence of vibration transmitted from a base of a vibration isolation device.

According to an aspect of the present invention, there is provided a machine tool for machining a workpiece using a tool, including: an vibration isolation device provided on a base and configured to isolate vibration transmitted from the base; a pedestal provided on the vibration isolation device and on which a machine tool main body is disposed; a container provided on the base and configured to store liquid, wherein a hose is connected to the container in order to discharge the stored liquid; and a flow path provided in the pedestal and configured to cause the liquid flowing out from the machine tool main body to flow to an end portion of the pedestal and fall into the container.

According to the present invention, it is possible to physically separate the container provided on the base of the vibration isolation device and the flow path provided on the pedestal on the vibration isolation device. Therefore, it is possible to prevent vibration from propagating from the base of the vibration isolation device to the pedestal thereof. As a result, it is possible to reduce the influence of vibration from the base of the vibration isolation device.

### BRIEF DESCRIPTION OF DRAWINGS

FIG. 1 is a schematic view showing a machine tool of the present embodiment.

### DESCRIPTION OF THE INVENTION

A preferred embodiment of the present invention will be described below in detail with reference to the accompanying drawings.

### [Embodiment]

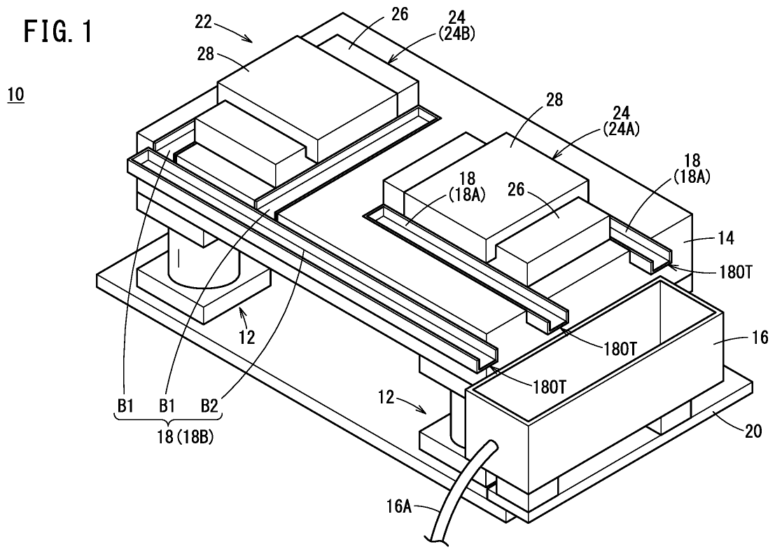

FIG. 1 is a schematic view showing a machine tool 10 according to the present embodiment. The machine tool 10 machines a workpiece (an object to be machined) by using a tool. The machine tool 10 may be a precision machine tool that machines a workpiece in accordance with a command with a machining accuracy of 100 nm or less. Further, the machine tool 10 may be a precision machine tool that machines a workpiece in accordance with a command with a machining accuracy of 10 nm or less. The command is defined by a machining program stored by the machine tool 10. The machine tool 10 includes a vibration isolation device 12, a pedestal 14, a container 16, and a flow path 18.

The vibration isolation device 12 is a device that isolates vibration transmitted from a base 20. The vibration isolation device 12 is provided on the base 20. The vibration isolation device 12 uses a spring system such as an air spring, a coil spring, or a vibration isolation rubber to isolate vibration transmitted from the base 20 by a damper. The vibration isolation device 12 may include a feedback mechanism that controls an actuator that drives the pedestal 14 using a sensor disposed on the pedestal 14, so as to suppress vibration of the pedestal 14. In addition, the vibration isolation device 12 may have a feedforward mechanism that controls an actuator that drives the pedestal 14 using a sensor disposed on the base 20, so as to suppress propagation of vibration from the base 20. Note that the number of the vibration isolation devices 12 may be one or more. FIG. 1 shows an example in which four vibration isolation devices 12 are disposed at the four corners of the lower surface of the pedestal 14, respectively.

The pedestal 14 is a table on which a machine tool main body 22 is disposed. The pedestal 14 is provided on the vibration isolation devices 12. The machine tool main body 22 includes a linear motion mechanism 24 disposed on the upper surface of the pedestal 14. The linear motion mechanism 24 is a mechanism that moves along one direction. The linear motion mechanism 24 includes a guide rail 26 extending in one direction and a slider 28 that slides on the guide rail 26. The number of the linear motion mechanisms 24 may be one or more.

In the present embodiment, the linear motion mechanism 24 includes a first linear motion mechanism 24A that is movable along a first direction, and a second linear motion mechanism 24B that is movable along a second direction orthogonal, in a plane, to the first direction. The guide rail 26 of the first linear motion mechanism 24A extends in the first direction, and the guide rail 26 of the second linear motion mechanism 24B extends in the second direction.

The container 16 is a container capable of storing liquid. The container 16 is provided on the base 20. When an oil bearing is formed between the guide rail 26 and the slider 28, the liquid stored in the container 16 contains oil. When cutting fluid is sprayed onto the workpiece during machining, the liquid stored in the container 16 includes the cutting fluid. A hose 16A for discharging the stored liquid is connected to the container 16. The liquid stored in the container 16 is sucked by a pump through the hose 16A.

The flow path 18 is a path that enables the liquid flowing out from the machine tool main body 22 to flow to the end portion of the pedestal 14 therethrough and to then drop into the container 16. The flow path 18 is provided in the pedestal 14. The entire flow path 18 may be provided on the upper surface of the pedestal 14. Alternatively, a portion thereof may be provided on the upper surface of the pedestal 14 and the remaining portion thereof may be provided outside the pedestal 14. That is, the flow path 18 is provided at least on the upper surface of the pedestal 14. The flow path 18 provided on the upper surface of the pedestal 14 may be a groove formed in the pedestal 14 or may be a member fitted into the groove.

A discharge port 18OT of the flow path 18 is located above the container 16 at a distance from the container 16. That is, the flow path 18 and the container 16 are not in contact with each other. The flow path 18 provided on the pedestal 14 on the vibration isolation device 12 is physically separated from the container 16 provided on the base 20 of the vibration isolation device 12. In the present embodiment, the flow path 18 includes a first flow path 18A and a second flow path 18B.

The first flow path 18A is disposed on each of both sides of the guide rail 26 of the first linear motion mechanism 24A, and linearly extends along the guide rail 26. One end of each first flow path 18A is closed, and the other end of each first flow path 18A is open. The other end of each first flow path 18A is the discharge port 18OT. Each first flow path 18A receives liquid flowing out from the first linear motion mechanism 24A and causes the received liquid to fall from the discharge port 18OT into the container 16.

The second flow path 18B includes a first portion B1 and a second portion B2. The first portion B1 is disposed on each of both sides of the guide rail 26 of the second linear motion mechanism 24B and linearly extends along the guide rail 26. One end of each first portion B1 is closed, and the other end of each first portion B1 is open. The second portion B2 is provided outside the pedestal 14 and below the other end of each first portion B1, and linearly extends along the first direction in which the first linear motion mechanism 24A moves. One end of the second portion B2 is closed, and the other end of the second portion B2 is open. The other end of the second portion B2 is the discharge port 18OT. In the second flow path 18B, liquid flowing out from the second linear motion mechanism 24B is received by the first portion B1, the received liquid is caused to flow from the other end of the first portion B1 to the second portion B2, and is caused to fall into the container 16 from the discharge port 18OT of the second portion B2.

As described above, in the machine tool 10 of the present embodiment, the container 16 provided on the base 20 of the vibration isolation device 12 and the flow path 18 provided on the pedestal 14 on the vibration isolation device 12 are physically separated from each other. Thus, even when vibration generated in the base 20 is transmitted to the container 16 or vibration generated by the pump is transmitted to the container 16 via the hose 16A, the vibration transmitted to the container 16 can be prevented from being propagated to the pedestal 14 on the vibration isolation device 12. As a result, it is possible to reduce the influence of vibration from the base 20 of the vibration isolation device 12.

Note that the discharge port 18OT of the flow path 18 may be positioned at an end portion of the pedestal 14. Alternatively, as shown in FIG. 1, the discharge port 18OT of the flow path 18 may be positioned outward of the end portion of the pedestal 14. In a case where the discharge port 18OT of the flow path 18 is positioned outside the end portion of the pedestal 14, it is possible to suppress the liquid falling from the discharge port 18OT from flowing on the peripheral side surface of the pedestal 14.

The volume of the flow path 18 may be smaller than the volume of the container 16. In such a volume relationship, it is possible to suppress leakage of liquid from the container 16. Specifically, for example, when, in response to occurrence of a power failure or the like, the supply of liquid in the machine tool main body 22 comes to a stop and the pump that suctions liquid stored in the container 16 via the hose 16A comes to a stop, it is possible to prevent leakage of the liquid remaining in the flow path 18 from the container 16.

In addition, the flow path 18 may be inclined such that the closer to the end portion of the pedestal 14, the lower the height of the flow path from the base 20. In the case of the present embodiment, the first flow path 18A is inclined such that the height of the flow path from the base 20 becomes lower toward an end on the short side of the rectangular-parallelepiped-shaped pedestal 14 along the first direction in which the guide rail 26 of the first linear motion mechanism 24A extends. The first portion B1 of the second flow path 18B is inclined such that the height of the flow path from the base 20 becomes lower toward an end on the long side of the rectangular-parallelepiped-shaped pedestal 14 along the second direction in which the guide rail 26 of the second linear motion mechanism 24B extends. Similarly to the first flow path 18A, the second portion B2 of the second flow path 18B is inclined such that the height of the flow path from the base 20 becomes lower toward an end on the short side of the rectangular-parallelepiped-shaped pedestal 14 along the first direction in which the guide rail 26 of the first linear motion mechanism 24A extends. In a case where the flow path 18 is inclined such that the height of the flow path from the base 20 becomes lower toward the end portion of the pedestal 14, liquid flowing out from the machine tool main body 22 easily flows to the end portion of the pedestal 14.

### [Invention]

The invention that can be understood from the above embodiment will be described below.

The present invention resides in a machine tool (10) for machining a workpiece using a tool. The machine tool (10) includes an vibration isolation device (12) provided on a base (20) and configured to isolate vibration transmitted from the base (20); a pedestal (14) provided on the vibration isolation device (12) and on which a machine tool main body (22) is disposed; a container (16) provided on the base (20) and configured to store liquid, wherein a hose (16A) is connected to the container (16) in order to discharge the stored liquid; and a flow path (18) provided in the pedestal (14) and configured to cause the liquid flowing out from the machine tool main body (22) to flow to an end portion of the pedestal (14) and fall into the container (16).

This makes it possible to physically separate the container (16) provided on the base (20) of the vibration isolation device (12) and the flow path (18) provided on the pedestal (14) on the vibration isolation device (12) from each other, and to block propagation of vibration from the base (20) of the vibration isolation device (12) to the pedestal (14) thereof. As a result, it is possible to reduce the influence of vibration from the base (20) of the vibration isolation device (12).

The flow path (18) and the container (16) may not be in contact with each other. As a result, the container (16) provided on the base (20) of the vibration isolation device (12) is physically separated from the flow path (18) provided on the pedestal (14) on the vibration isolation device (12).

The flow path (18) may be inclined such that the height of the flow path from the base (20) becomes lower towards the end portion of the pedestal (14). Accordingly, the liquid flowing out from the machine tool main body (22) can easily flow to the end portion of the pedestal (14).

The discharge port (18OT) of the flow path (18) may be located outward of the end portion of the pedestal (14). Accordingly, it is possible to prevent the liquid falling from the discharge port (18OT) from flowing on the peripheral side surface of the pedestal (14).

The volume of the flow path (18) may be less than the volume of the container (16). Accordingly, it is possible to prevent leakage of liquid from the container (16).

The machine tool (10) may be a precision machine tool that machines a workpiece in accordance with a command with a machining accuracy of 100 nm or less. As a result, it is possible to suppress an adverse effect on the machining accuracy of a precision machine tool.

1. A machine tool for machining a workpiece using a tool, the machine tool comprising:
a vibration isolation device provided on a base and configured to isolate vibration transmitted from the base;
a pedestal provided on the vibration isolation device and on which a machine tool main body is disposed;
a container provided on the base and configured to store liquid, wherein a hose is connected to the container in order to discharge the stored liquid; and
a flow path provided in the pedestal and configured to cause the liquid flowing out from the machine tool main body to flow to an end portion of the pedestal and fall into the container.

2. The machine tool according to claim 1, wherein
the flow path and the container are not in contact with each other.

3. The machine tool according to claim 1, wherein
the flow path is inclined in a manner that a height of the flow path from the base becomes lower toward the end portion of the pedestal.

4. The machine tool according to claim 1, wherein
a discharge port of the flow path is located outward of the end portion of the pedestal.

5. The machine tool according to claim 1, wherein
a volume of the flow path is smaller than a volume of the container.

6. The machine tool according to claim 1, wherein
the machine tool is a precision machine tool that machines the workpiece in accordance with a command with a machining accuracy of 100 nm or less.
